(19) United States
(12) Patent Application Publication
(10) Pub. No.: US 2013/0162376 A1
(43) Pub. Date: Jun. 27, 2013

(54) DC BLOCK USING MICROSTRIP LINE

(71) Applicant: KOREA ELECTRONICS TECHNOLOGY INSTITUTE, Seongnam-si (KR)

(72) Inventors: Se Hwan Choi, Seongnam-si (KR); Gyu Bok Lee, Seongnam-si (KR)

(73) Assignee: KOREA ELECTRONICS TECHNOLOGY INSTITUTE, Seongnam-si (KR)

(21) Appl. No.: 13/727,228

(22) Filed: Dec. 26, 2012

(30) Foreign Application Priority Data
Dec. 27, 2011 (KR) 10-2011-0143067

(51) Int. Cl. H01P 3/08

(52) U.S. Cl. CPC H01P 3/081
USPC 333/246

(57) ABSTRACT

A DC block is provided. The present DC block includes a first microstrip line of which one end is connected to a first signal line and of which the other end is bent; and a second microstrip line of which one end is connected to a second signal line, and of which the other end is bent, wherein the second microstrip line is placed parallel to the first microstrip line. Accordingly, the size of the DC block is reduced by at least half.

### CROSS-REFERENCE TO RELATED APPLICATIONS

This application claims priority from Korean Patent Application No. 10-2011-0143067, filed in the Korean Intellectual Property Office on Dec. 27, 2011, the disclosure of which is incorporated herein by reference.

### BACKGROUND OF THE INVENTION

1. Field of the Invention

Methods and apparatuses consistent with the exemplary embodiments relate to a DC block, and more particularly to a DC block using microstrip lines.

2. Description of the Prior Art

In general, ultra wideband communication enables high speed data transmission with a very low power by using very broad frequency bands. A frequency band used in ultra wideband communication is 3.1˜10.6 GHz, of which 5.15˜5.825 GHz frequency band is the frequency band used in HIPERLAN/2 or IEEE 802.11a etc. which are communication service standards of WLAN which is a wireless LAN. The power usage of this band is approximately 70 dB higher than that of ultra wideband communication, and since ultra wideband communication signals and wireless LAN signals may generate mutual interruption in this frequency band, methods have been proposed for removing signals of wireless LAN frequency band from among ultra wideband communication signals.

Of these methods, the most generally used method is a method of using BSF (Band Stop Filter) at a terminal end of an RF communication system. But when using BSF, the efficiency of the communication system decreases and the size gets bigger.

Meanwhile, generally, an active circuit refers to a circuit which includes non-linear elements such as FET, BJT, and diode etc. Amplifiers, oscillators, mixers, frequency doublers, phase shifters etc. are different types of an active circuit.

In the case of using such an active circuit in an RF communication system, a signal line which transmits signals and a DC block which prevents the active circuit from being directly connected are installed.

A DC block prevents DC power from flowing into a signal line thereby affecting signals. Capacitors were mainly used as DC blocks since now. However, in the case of using a capacitor in an ultra high frequency, ultra wideband system such as a UWB system, magnetic resonance is generated, and sometimes unwanted satellite constituents are generated as well. Accordingly, there are disadvantages that characteristics of the capacitor are not guaranteed, efficiency decreases, and prices increase.

In order to resolve these problems, DC blocks using microstrip lines have been proposed. A DC block consists of a pair of microstrip lines placed parallel to each other, which electrically block at each end of the microstrip line, thereby playing a role of a DC open circuit.

An existing DC block which uses a microstrip line has a length of λ/4 (λ being a wavelength of the frequency band to be passed) regarding the frequency band to be passed. Thus, its size is too big to be used in a frequency band which is lower than 10 GHz band. An alternative is to form a BPF using a chip type inductor and a capacitor, which also has poor performance in a band of 5 GHz or more, due to the performance of the chip.

Accordingly, it is required to seek a measure to embody a DC block using small microstrip lines.

### SUMMARY OF THE INVENTION

The purpose of the present invention is to provide a DC block which includes a first microstrip line of which one end is connected to a first signal line and of which the other end is bent, and a second microstrip line of which one end is connected to a second signal line and of which the other end is bent, wherein the second microstrip line is placed parallel to the first microstrip line.

According to an exemplary embodiment of the present invention, a DC block includes a first microstrip line of which one end is connected to a first signal line and of which the other end is bent; and a second microstrip line which is placed parallel to the first microstrip line, and of which one end is connected to a second signal line and the other end is bent.

In addition, the DC may further include a first sub microstrip line which is placed parallel to the first microstrip line, and of which one end is connected to the bent other end of the first microstrip line and of which the other end is placed to face towards the first signal line.

Furthermore, the DC block may further include a second sub microstrip line which is placed parallel to the second microstrip line, and of which one end is connected to the bent other end of the second microstrip line, and of which the other end is placed to face towards the second signal line.

In addition, each of the first microstrip line, first sub microstrip line, second microstrip line, and second sub microstrip line may have a length of λ/8 (λ being a wavelength of a signal to be transmitted).

Furthermore, the first microstrip line and first sub microstrip line may be distanced from each other by more than a thickness of a substrate.

In addition, the second microstrip line and second sub microstrip line may be distanced from each other by more than a thickness of a substrate.

According to an exemplary embodiment of the present invention, the DC block includes a first microstrip line of which one end is connected to a first signal line, and of which the other end is bent to face towards the first signal line, thereby the two ends placed parallel to each other; and a second microstrip line of which one end is connected to a second signal line, and of which the other end is bent to face towards the first signal line, thereby the two ends placed parallel to each other.

### BRIEF DESCRIPTION OF THE DRAWINGS

The above and/or other aspects of the present disclosure will be more apparent by describing certain present disclosure with reference to the accompanying drawings, in which:

FIG. 1 is a view illustrating a structure of a DC block, according to an exemplary embodiment of the present invention; and

FIG. 2 is a view modeling a process of reducing a size of a microstrip line of an existing DC block by bending it, according to an exemplary embodiment of the present invention.

### DETAILED DESCRIPTION OF THE INVENTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

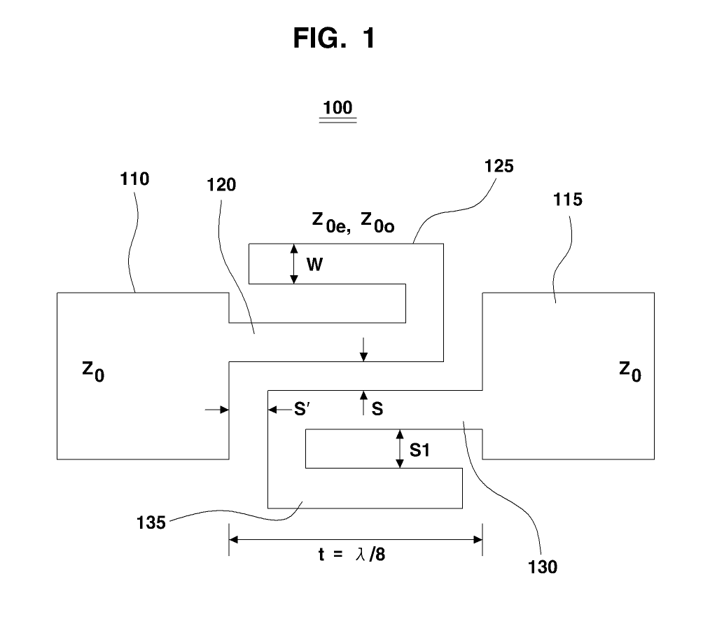

FIG. 1 is a view illustrating a structure of a DC block 100, according to an exemplary embodiment of the present invention. As illustrated in FIG. 1, the DC block 100 includes a first signal line 110, second signal line 115, first microstrip line 120, first sub microstrip line 125, second microstrip line 130, and second sub microstrip line 135. As illustrated in FIG. 1, the DC block according to the present exemplary embodiment is a DC block using microstrip lines.

The first signal line 110 and second signal line 115 are transmission lines for transmitting signals between each other. More specifically, the first signal line 110 and second signal line 115 transmit signals, and the wavelength of the transmitted signal is λ. A signal may be transmitted from the first signal line 110 to the second signal line 115, or from the second signal line 115 to the first signal line 110.

As illustrated in FIG. 1, the first microstrip line 120 has its one end connected to the first signal line, and its other end bent to face towards the first signal line, and thus the two ends are placed parallel to each other. More specifically, the first microstrip line 120 has its one end connected to the first signal line 110 and its other end bent to form a first sub microstrip line 125. The first sub microstrip line 125 has its one end connected to the other end of the first microstrip line 120 which is bent, and its other end facing towards the first signal line 110. In addition, the first sub microstrip line 125 is placed parallel to the first microstrip line 120. As such, the first microstrip line 120 is bent, forming the first sub microstrip line 125, and thus the two being placed parallel to each other. In addition, in the present exemplary embodiment, the first microstrip line 120 and first sub microstrip line 125 were explained to be formed separately, but this is for convenience of explanation, and thus the first microstrip line 120 and first sub microstrip line 125 is embodied as one microstrip line bent and connected to each other.

In addition, as illustrated in FIG. 1, the second microstrip line 130 has its one end connected to the second signal line 115, and its other end bent to face towards the second signal line, and thus the two ends are placed parallel to each other. More specifically, the one end of the second microstrip line 130 is connected to the second signal line 115, and the other end is bent to form the second sub microstrip line 135. The one end of the second sub microstrip line 135 is connected to the other end of the second microstrip line which is bent, and the other end of the second sub microstrip line 135 is placed to face towards the second signal line 115. In addition, the second sub microstrip line 135 is placed parallel to the second microstrip line 130. As such, the second microstrip line 130 is bent to form the second sub microstrip line 135, and thus the second microstrip line 130 and the second sub microstrip line 135 are placed parallel to each other. In addition, in the present exemplary embodiment, the second microstrip line 130 and the second sub microstrip line 135 were explained as separately formed, but this is for convenience of explanation, and thus the second microstrip line 130 and the second sub microstrip line 135 are embodied as one microstrip line bent and connected to each other.

As illustrated in FIG. 1, in this structure, the first microstrip line 120 and first sub microstrip line 125 are not connected to the second microstrip line 130 and second sub microstrip line 135, and thus in a case where a signal of the first signal line 110 is direct current, it is not transmitted to the second signal line 115, and in a case where a signal of the first signal line 110 is alternating current, it is transmitted to the second signal line 115 by an electromagnetic induction.

As such, each of the first microstrip line 120 and second microstrip line 130 is bent to be formed in twofold, and thus its length becomes shorter than an existing DC block. More specifically, the length of the first microstrip line 120, first sub microstrip line 125, second microstrip line 130, and second sub microstrip line 135 each becomes λ/8 (λ being a wavelength of a signal to be transmitted). Considering that the length of a microstrip line of an existing DC block is λ/4, it can be seen that the length is reduced by at least half.

In addition, the first microstrip line 120 and first sub microstrip line 125 are placed such that a distance therebetween S1 is wider than a thickness of a substrate. In addition, the second microstrip line 130 and second sub microstrip line 135 are also placed such that a distance therebetween is wider than a thickness of a substrate. This is to maintain performances of the miniaturized DC block.

In addition, the first microstrip line 120 and second microstrip line 130 are also placed such that a distance therebetween S is shorter than an existing DC block. This is to compensate for a degree of coupling that has been lost due to a reduction of length of the first microstrip line 120 and second microstrip line 130.

A DC block of such a structure has a length shorter than at least half of an existing DC block, and thus it becomes possible to miniaturize the DC block with similar performances.

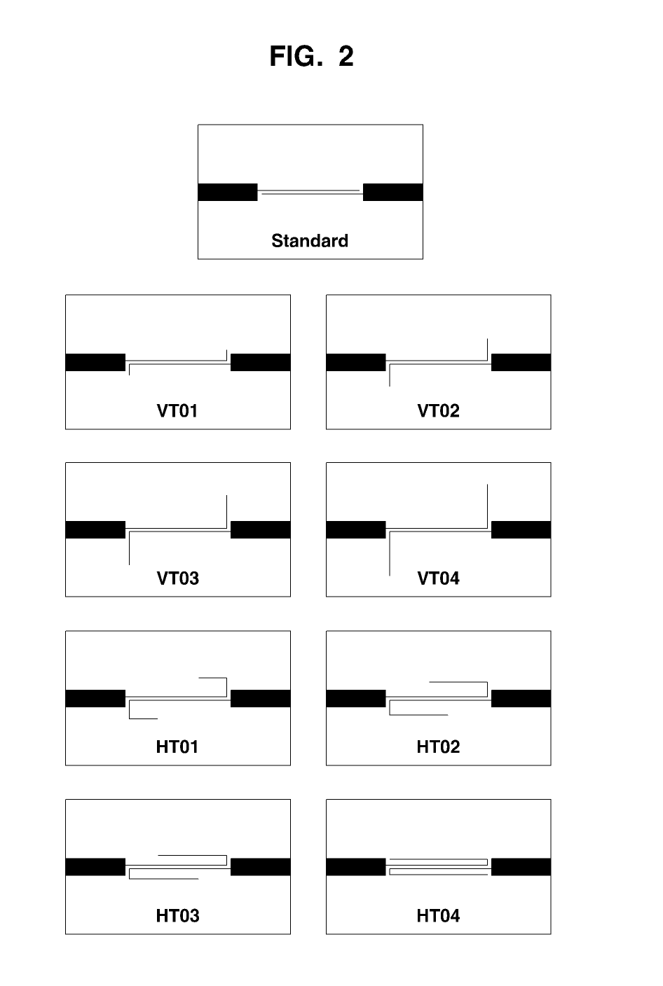

FIG. 2 is a view modeling a process of miniaturizing the size by bending a microstrip line of an existing DC block.

The formula below shows VSWR (Voltage Standing Wave Ratio) and insertion loss characteristics of a general DC block.

$$\begin{matrix}VSWR = \frac{\vert Zin 1 + Z 0 \vert + \vert Zin 1 - Z 0 \vert}{\vert Zin 1 + Z 0 \vert - \vert Zin 1 - Z 0 \vert} \\ = 1 / {sin}^{2} ( θ )\end{matrix}$$

$$T = 20 {log}_{10} ( \frac{2 sin ( θ )}{1 + sin 2 ( θ )} ) ( in dB )$$

Zᵢₙ₁: Input impedance of port 1

Z₀: Characteristic impedance of line

⊖: Electrical length

Herein, it can be seen that characteristics of a DC block is mainly determined by ⊖, and that a degree of coupling of two microstrip lines is determined by a distance s. By using these characteristics, as illustrated in FIG. 2, through processes from VT01 to VT04, it becomes possible to reduce an entire length of a microstrip line while bending it upwards to maintain the length of ⊖, thereby reducing the length of the DC block. Herein, it can be seen that the microstrip lines have been placed such that the distance s therebetween gradually decreases, so as to compensate for loss of degree of coupling due to the shortened length in the processes from VT01 to VT04.

Thereafter, when moving from HT01 to the final HT04 model, the line protruding to the left is bent 90° again, thereby reducing the overall size.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A DC block comprising:
a first microstrip line of which one end is connected to a first signal line and of which the other end is bent; and
a second microstrip line which is placed parallel to the first microstrip line, and of which one end is connected to a second signal line and the other end is bent.

2. The DC block according to claim 1, further comprising a first sub microstrip line which is placed parallel to the first microstrip line, and of which one end is connected to the bent other end of the first microstrip line and of which the other end is placed to face towards the first signal line.

3. The DC block according to claim 2, further comprising a second sub microstrip line which is placed parallel to the second microstrip line, and of which one end is connected to the bent other end of the second microstrip line, and of which the other end is placed to face towards the second signal line.

4. The DC block according to claim 3,
wherein each of the first microstrip line, first sub microstrip line, second microstrip line, and second sub microstrip line has a length of λ/8 (λ0 being a wavelength of a signal to be transmitted)

5. The DC block according to claim 2,
wherein the first microstrip line and first sub microstrip line are distanced from each other by more than a thickness of a substrate

6. The DC block according to claim 3,
wherein the second microstrip line and second sub microstrip line are distanced from each other by more than a thickness of a substrate

7. A DC block comprising:
a first microstrip line of which one end is connected to a first signal line, and of which the other end is bent to face towards the first signal line, thereby the two ends placed parallel to each other; and
a second microstrip line of which one end is connected to a second signal line, and of which the other end is bent to face towards the first signal line, thereby the two ends placed parallel to each other
